(19) United States
(12) Patent Application Publication
(10) Pub. No.: US 2017/0282200 A1
(43) Pub. Date: Oct. 5, 2017

(54) ODOR GENERATOR DEVICE AND ODOR GENERATING METHOD BASED ON AN INTELLIGENT MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Shuai YANG, Beijing (CN)

(21) Appl. No.: 15/242,438

(22) Filed: Aug. 19, 2016

Related U.S. Application Data
(63) Continuation of application No. PCT/CN2016/088480, filed on Jul. 4, 2016.

(30) Foreign Application Priority Data
Mar. 29, 2016 (CN) 201610188572.6

(51) Int. Cl. B05B 12/02; H04M 1/725; H04W 52/02

(52) U.S. Cl. CPC B05B 12/02; H04W 52/0267; H04M 1/72527; H04M 1/7253; H04M 1/72547

(57) ABSTRACT

The present disclosure relates to an odor generator device based on an intelligent mobile terminal, including: a communication module configured to establish a communication connection with the intelligent mobile terminal and acquire electronized odor information from the intelligent mobile terminal; a data processing chip connected to the communication module to parse the received electronized odor information and generate a corresponding odor generating instruction according to decoded data; and an odor generator connected to the data processing chip to generate a corresponding odor according to the odor generating instruction and emit the odor. The present disclosure further provides an odor generating method based on an intelligent mobile terminal, comprising: an electronized odor information acquisition step, an electronized odor information parsing step, and an odor restoring step.

### CROSS-REFERENCE TO RELATED APPLICATIONS

This application is a continuation of International Application No. PCT/CN2016/088480, filed Jul. 4, 2016, which in turn claims priority to Chinese Application No. 201610188572.6, filed Mar. 29, 2016, the entire contents of which are herein incorporated by reference.

### TECHNICAL FIELD

The present disclosure relates to the technical field of intelligent equipment, and in particular, to an odor generator device and an odor generating method based on an intelligent mobile terminal.

### BACKGROUND

As the functions of intelligent mobile terminals based on mobile Internet, represented by smart phones and tablet personal computers, are increasingly stronger, people have become more and more dependent on the intelligent mobile terminals and have more diverse demands for the functions of the intelligent mobile terminals, thereby promoting further development of new functions of the intelligent mobile terminals.

Existing intelligent mobile terminals can transmit audiovisual information such as text, sound, images and video via the mobile Internet, and people are increasingly looking forward to make use of the intelligent mobile terminals to transmit more diverse information, including requirement for odor transmission.

The odor transmission cannot be implemented in absence of an odor generator for restoring an odor from received odor information. In the prior art, the existing odor generator can generate a corresponding odor according to an instruction and emit the odor, so that a user can smell the odor and obtain a corresponding user experience. With the progress of technology, odors that can be generated by the existing odor generator are very rich, and substantially cover most of odors that can be distinguished by human sense of smell. However, all of the existing odor generators are solely applied. For example, an odor generator is used for manufacturing an electronic aroma device or the like, in which the odor that can be generated is preset by the manufacturer, thus the user cannot freely set a desired odor. Also, there is no technical report of connecting the odor generator with an intelligent mobile terminal to achieve odor transmission.

### SUMMARY

The technical problem to be solved by the present disclosure is to provide an odor generator device based on an intelligent mobile terminal, which can restore a corresponding odor according to received electronized odor information to achieve odor transmission, so as to improve the user experience.

The technical problem to be further solved by the present disclosure is to provide an odor generating method based on an intelligent mobile terminal, by means of which a corresponding odor can be restored according to received electronized odor information to achieve odor transmission, so as to improve the user experience.

To solve the above technical problems, the present disclosure provides the following technical solutions: an odor generator device based on an intelligent mobile terminal, including:

a communication module configured to establish a communication connection with the intelligent mobile terminal and acquire electronized odor information from the intelligent mobile terminal;

a data processing chip connected to the communication module to parse the received electronized odor information and generate a corresponding odor generating instruction according to decoded data; and

an odor generator connected to the data processing chip to generate a corresponding odor according to the odor generating instruction and emit the odor.

Further, the communication module includes at least any of a wireless communication module and a wired communication module; the wireless communication module is any of a Bluetooth communication module, an infrared communication module and a WIFI communication module; and the wired communication module is a USB port or a Micro USB port connected to the intelligent mobile terminal via a USB connecting wire.

Further, the odor generator device includes a power module for providing power.

Further, the power module is provided with a wireless charging assembly, which cooperates with the intelligent mobile terminal having a wireless sensing power supply assembly to obtain power supply from the intelligent mobile terminal in a wireless mode.

Further, the power module is provided with a USB power supply circuit, which has a USB port or a Micro USB port connected to the intelligent mobile terminal via a USB connecting wire.

Further, the odor generator includes an odor element storage unit storing a plurality of odor elements and an excitation unit for exciting the odor elements in the odor element storage unit to form corresponding odors and emit the odors.

Further, the odor element storage unit is detachably installed in the odor generator, and the odor elements are stored in the odor element storage unit in a solid, liquid or gaseous form.

In another aspect, the present disclosure further provides an odor generating method based on an intelligent mobile terminal, including the following steps:

an electronized odor information acquisition step: establishing a data connection between an odor generator device and the intelligent mobile terminal and acquiring electronized odor information from the intelligent mobile terminal;

an electronized odor information parsing step: parsing the received electronized odor information by a data processing chip to determine type and concentration of oder and generating a corresponding odor generating instruction; and

an odor restoring step: generating a corresponding odor by an odor generator according to the odor generating instruction and emitting the odor.

Further, in the electronized odor information acquisition step, a wireless communication connection is established between the odor generator device and the intelligent mobile terminal, or a wired communication connection is established between the odor generator device and the intelligent mobile terminal via a USB connecting wire.

Further, an original odor element storage unit is replaced by a new odor element storage unit when the remaining amount of odor elements stored in the odor element storage unit is lower than a lower limit of the remaining amount required for normal operation.

The present disclosure further provides a computer storage medium, wherein the computer-readable storage medium stores computer-executable instructions which, when executed, cause an odor generator device based on an intelligent mobile terminal to execute operations including:

an electronized odor information acquisition step: establishing a data connection between the odor generator device and the intelligent mobile terminal and acquiring electronized odor information from the intelligent mobile terminal;

an electronized odor information parsing step: parsing the received electronized odor information by a data processing chip to determine type and concentration of oder, and generating a corresponding odor generating instruction; and

an odor restoring step: generating a corresponding odor by an odor generator according to the odor generating instruction and emitting the odor.

By adopting the above technical solutions, the present disclosure has at least the following beneficial effects: through establishing a connection between the odor generator device and the intelligent mobile terminal in the present disclosure, electronized odor information can be acquired from the intelligent mobile terminal and parsed, and a corresponding odor is eventually generated and emitted. Particularly, without hardware modification or upgrade of the existing intelligent mobile terminal, odor transmission can be achieved between two intelligent mobile terminal users only by installing an application program, and one user can have an experience corresponding to the odor information sent by another user, so that the user experience is greatly improved.

### BRIEF DESCRIPTION OF THE DRAWINGS

To illustrate more clearly the technical solutions of the embodiments of the present disclosure or the prior art, the drawings for the description of the embodiments or the prior art will be introduced briefly as follows. Apparently, the drawings in the description below are merely used for description of some embodiments of the present disclosure, and ordinary skill in the art can further obtain other figures according to these figures without creative work.

FIG. 1 is a principle diagram of cooperation between an odor generator device based on an intelligent mobile terminal of the present disclosure and the intelligent mobile terminal;

FIG. 2 is a principle block diagram of an odor generator device based on an intelligent mobile terminal of the present disclosure;

FIG. 3 is a flow schematic diagram of steps of an odor generating method based on an intelligent mobile terminal of the present disclosure;

### DETAILED DESCRIPTION

It should be noted that the embodiments in the present disclosure and the features in the embodiments can be combined with one another without conflicts. The present disclosure is further described in detail below in combination with the accompanying drawings and the specific embodiments.

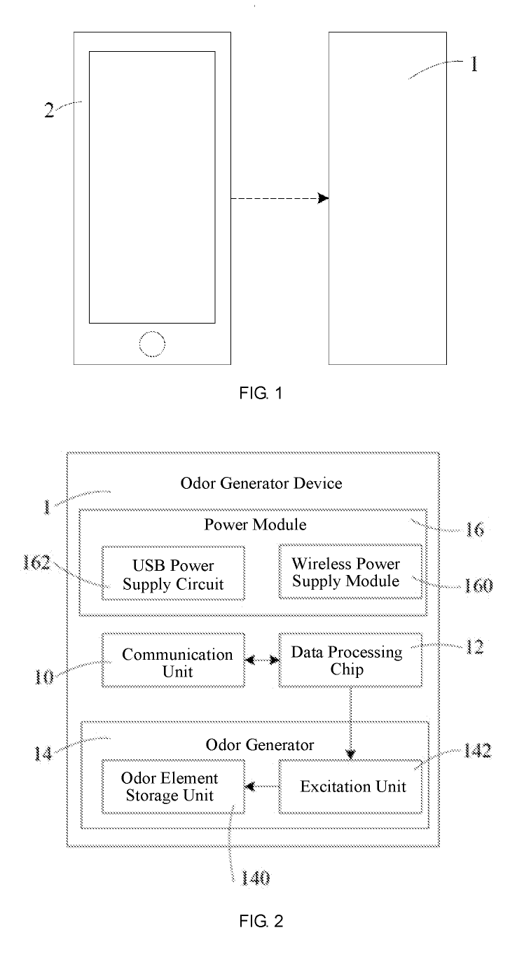

As shown in FIG. 1, the present disclosure provides an odor generator device 1 based on an intelligent mobile terminal, which achieves data communication with the intelligent mobile terminal 2 and generates a corresponding odor according to the instruction emitted by the intelligent mobile terminal 2. As shown in FIG. 2, the odor generator device 1 includes:

a communication module 10 configured to establish a communication connection with the intelligent mobile terminal 2 and acquire electronized odor information from the intelligent mobile terminal 2;

a data processing chip 12 connected to the communication module 10 to parse the received electronized odor information and generate a corresponding odor generating instruction according to decoded data; and

an odor generator 14 connected to the data processing chip 12 to generate a corresponding odor according to the odor generating instruction and emit the odor.

Data communication can be achieved between the odor generator device 1 and the intelligent mobile terminal 2 in a wireless or wired mode. For example, the communication module 10 may be a Bluetooth communication module, an infrared communication module or a WIFI communication module which is commonly used in short-range wireless communication. Or alternatively, a wired communication connection can be achieved by plugging both ends of a USB connecting wire to the odor generator device 1 and the intelligent mobile terminal 2 respectively, and the odor generator device 1 is correspondingly provided with a USB port or a Micro USB port.

The intelligent mobile terminal 2 that can be used for application in cooperation with the odor generator device 1 may be a common portable intelligent terminal based on mobile Internet, such as a mobile phone, a tablet personal computer or the like. One intelligent mobile terminal can acquire the electronized odor information in various ways, for example, by establishing a communication connection with other intelligent mobile terminals to exchange data so as to acquire the electronized odor information, downloading the electronized odor information from a cloud server via mobile Internet, or directly inputting the electronized odor information by hardware such as a touch screen of the intelligent mobile terminal.

The odor generator device 1 further includes a power module 16 for providing power. The power module 16 may be a built-in battery and a power supply circuit thereof. Moreover, the power module 16 may also be the one connected with a mobile phone to obtain power supply therefrom. In one embodiment, the power module 16 may be provided with a wireless charging assembly 160, which cooperates with the intelligent mobile terminal 2 having a wireless sensing power supply assembly to obtain power supply from the intelligent mobile terminal 2 in a wireless mode. In another embodiment, the power module 16 is further provided with a USB power supply circuit 162, which has a USB port or a Micro USB port connected to the intelligent mobile terminal 2 via a USB connecting wire.

The odor generator 14 includes an odor element storage unit 140 storing a plurality of odor elements and an excitation unit 142 for exciting the odor elements in the odor element storage unit 140 to form corresponding odors and emit the odors. The odor element storage unit stores odor elements in a solid, liquid or gaseous form, and a corresponding odor element is excited according to the corresponding instruction to form the odor which can be distinguished by the sense of smell. The working principle of the odor generator 14 is basically the same as that of the existing odor generator, and will not be redundantly described herein. For the sake of convenience in use, the odor element storage unit 140 is detachably installed in the odor generator 14, and thus can be conveniently detached and replaced.

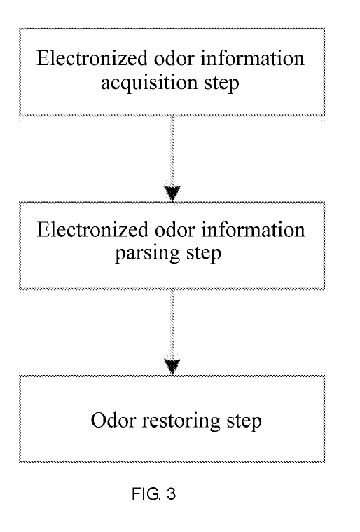

In another aspect, as shown in FIG. 3, the present disclosure further provides an odor generating method based on an intelligent mobile terminal, including the following steps:

an electronized odor information acquisition step: establishing a data connection between an odor generator device and the intelligent mobile terminal and acquiring electronized odor information from the intelligent mobile terminal;

an electronized odor information parsing step: parsing the received electronized odor information by a data processing chip to determine type and concentration of oder, and generating a corresponding odor generating instruction; and

an odor restoring step: generating a corresponding odor by an odor generator according to the odor generating instruction and emitting the odor.

During specific implementation, in the electronized odor information acquisition step, a wireless communication connection may be established between the odor generator device 1 and the intelligent mobile terminal 2, or a wired communication connection is established between the odor generator device 1 and the intelligent mobile terminal 2 via a USB connecting wire.

The odor element storage unit 140 is detachable and replaceable. When the remaining amount of the odor elements stored in the odor element storage unit 140 is lower than a lower limit of the remaining amount required for normal operation, the original odor element storage unit 140 can be replaced by a new odor element storage unit. Therefore, quick maintenance is facilitated, and the odor type available can also be renewed.

In an embodiment of the present disclosure, it is further provided a non-transitory computer-readable storage medium storing executable instructions that, when executed by an electronic device with a touch-sensitive display, cause the electronic device to execute the processing methods for operations in the embodiments of any of the methods described above.

The electronic apparatus in the embodiment of the present disclosure exists in various forms, including but not limited to:

(1) mobile communication apparatus, characterized in having a function of mobile communication mainly aimed at providing speech and data communication, wherein such terminal includes: smart phone (such as iPhone), multimedia phone, functional phone, low end phone and the like;

(2) ultra mobile personal computer apparatus, which falls in a scope of personal computer, has functions of calculation and processing, and generally has characteristics of mobile internet access, wherein such terminal includes: PDA, MID and UMPC devices, such as iPad;

(3) portable entertainment apparatus, which can display and play multimedia contents, anc includes audio or video player (such as iPod), portable game console, E-book and intelligent toys and portable vehicle navigation apparatus;

(4) server, an apparatus for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network apparatus or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. An odor generator device based on an intelligent mobile terminal, comprising:
a communication module, configured to establish a communication connection with the intelligent mobile terminal and acquire electronized odor information from the intelligent mobile terminal;
a data processing chip, connected to the communication module to parse the received electronized odor information and generate a corresponding odor generating instruction according to decoded data; and
an odor generator, connected to the data processing chip to generate a corresponding odor according to the odor generating instruction and emit the odor.

2. The odor generator device based on the intelligent mobile terminal according to claim 1, wherein the communication module comprises at least any of a wireless communication module and a wired communication module; the wireless communication module is any of a Bluetooth communication module, an infrared communication module and a WIFI communication module; and the wired communication module is a USB port or a Micro USB port connected to the intelligent mobile terminal via a USB connecting wire.

3. The odor generator device based on the intelligent mobile terminal according to claim 1, wherein the odor generator device further comprises a power module for providing power.

4. The odor generator device based on the intelligent mobile terminal according to claim 3, wherein the power module is provided with a wireless charging assembly, which cooperates with the intelligent mobile terminal having a wireless sensing power supply assembly to obtain power supply from the intelligent mobile terminal in a wireless mode.

5. The odor generator device based on the intelligent mobile terminal according to claim 3, wherein the power module is further provided with a USB power supply circuit, which has a USB port or a Micro USB port connected to the intelligent mobile terminal via a USB connecting wire.

6. The odor generator device based on the intelligent mobile terminal according to claim 1, wherein the odor generator comprises an odor element storage unit storing a plurality of odor elements and an excitation unit for exciting the odor elements in the odor element storage unit to form corresponding odors and emit the odors.

7. The odor generator device based on an intelligent mobile terminal according to claim 1, wherein the odor element storage unit is detachably installed in the odor generator, and the odor elements are stored in the odor element storage unit in a solid, liquid or gaseous form.

8. An odor generating method based on an intelligent mobile terminal, comprising the following steps:
an electronized odor information acquisition step: establishing a data connection between an odor generator device and the intelligent mobile terminal and acquiring electronized odor information from the intelligent mobile terminal;
an electronized odor information parsing step: parsing the received electronized odor information by a data processing chip to determine type and concentration of oder and generating a corresponding odor generating instruction; and
an odor restoring step: generating a corresponding odor by an odor generator according to the odor generating instruction and emitting the odor.

9. The odor generating method based on the intelligent mobile terminal according to claim 8, wherein in the electronized odor information acquisition step, a wireless communication connection is established between the odor generator device and the intelligent mobile terminal, or a wired communication connection is established between the odor generator device and the intelligent mobile terminal via a USB connecting wire.

10. The odor generating method based on the intelligent mobile terminal according to claim 8, wherein an original odor element storage unit is replaced by a new odor element storage unit when the remaining amount of odor elements stored in the odor element storage unit is lower than a lower limit of the remaining amount required for normal operation.

11. A non-transitory computer-readable storage medium storing executable instructions that, when executed by an electronic device with a touch-sensitive display, cause the electronic device to:
establish a data connection between an odor generator device and an intelligent mobile terminal and acquire electronized odor information from the intelligent mobile terminal;
parse the received electronized odor information by a data processing chip to determine type and concentration of oder, and generate a corresponding odor generating instruction; and
generate a corresponding odor by an odor generator according to the odor generating instruction and emit the odor.

12. The non-transitory computer storage medium according to claim 11, wherein the electronic device is further caused to:
establish a wireless communication connection between the odor generator device and the intelligent mobile terminal, or establish a wired communication connection between the odor generator device and the intelligent mobile terminal via a USB connecting wire.

13. The non-transitory computer storage medium according to claim 11, wherein the electronic device is further caused to:
replace an original odor element storage unit with a new odor element storage unit when the remaining amount of odor elements stored in the odor element storage unit is lower than a lower limit of the remaining amount required for normal operation.
